(19) United States
(12) Patent Application Publication
(10) Pub. No.: US 2004/0169434 A1
(43) Pub. Date: Sep. 2, 2004

(54) Slip ring apparatus

(76) Inventors: Richard G. Washington, Marble Falls, TX (US); Thao D. Hovanky, Austin, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 10/732,924

(22) Filed: Dec. 10, 2003

Related U.S. Application Data
(60) Provisional application No. 60/437,712, filed on Jan. 2, 2003.

(51) Int. Cl. H02K 1/00

(52) U.S. Cl. 310/232

(57) ABSTRACT

Slip ring apparatus that may be implemented to enable low profile rotating systems for a variety of different applications, such as articulated and non-articulated device applications. The assembly of the slip ring apparatus may be integrated into a printed circuit board (“PCB”) with feedback circuitry, and the number of signals crossing the slip ring rotational boundary may be minimized using serial electronics.

This patent application claims priority to copending United States Provisional Patent Application Serial No. 60/437,712, filed Jan. 2, 2003, and entitled “SLIP RING APPARATUS” by Washington et al., the entire disclosure of which is incorporated herein by reference.

### BACKGROUND OF THE INVENTION

The present invention relates generally to slip ring assemblies, and more particularly to pancake slip ring assemblies.

Existing contact-type cylindrical slip rings are typically configured as relatively long hollow cylindrical tubes with contacts and conducting wires attached inside of one of the tube shaped elements. Such slip rings may be employed in Closed Circuit Television (“CCTV”) applications to provide a rotating connection between a motor assembly and an optical block to allow the motor assembly to rotate the optical block at the same time that signals are transmitted to and from the camera assembly through the rotating connection.

FIGS. 1A, 1B and 2 illustrate examples of commercially available slip ring assemblies known in the art. In this regard, FIGS 1A and 1B illustrate the internal components of a commercially available slip ring apparatus 100 showing inner hollow cylindrical tube 110 of an inner assembly of the slip ring apparatus 100 that rotates within outer collar 120 of an outer assembly of the slip ring apparatus 100. An outer cylindrical tube that forms a part of the outer assembly of the slip ring apparatus 100 attaches to outer collar 120 to cover the internal components of the slip ring apparatus is not shown in order to reveal a view of the slip ring apparatus internal components. As shown, inner cylindrical tube 110 of the inner assembly has cylindrical inner assembly contacts 112 disposed on the outer surface of tube 110 for making contact with mating outer assembly spring contacts 114 that are attached to outer collar 120. Inner assembly conductor wires 116 connect to cylindrical inner assembly contacts 112, and outer assembly conductor wires 118 attach to outer assembly spring contacts 114. In operation, electrical signals may be transmitted between inner assembly conductor wires 116 and outer assembly conductor wires 118 through mating contacts 112 and 114 at the same time that inner cylindrical tube 1 10 of the inner assembly rotates relative to outer collar 120 of the outer assembly.

FIG. 2 illustrates an external view of an assembled commercially available slip ring apparatus 200, showing outer cylindrical tube 208 that covers the internal components of slip ring apparatus 200. Also shown in FIG. 2 is outer collar 220 that is attached to outer cylindrical tube 208 to form an outer assembly of the slip ring apparatus 200. As shown, outer assembly conductor wires 218 extend through the side of outer cylindrical tube 208 from outer assembly spring contacts (not shown) that are internally attached to the outer assembly of the slip ring apparatus 200. Also shown are inner assembly conductor wires 216 that extend out from one end of outer cylindrical tube from inner assembly cylindrical contacts (not shown) that are internally attached to the outer surface of an inner cylindrical tube (not shown) of an inner assembly of the slip ring apparatus 200. Similar to the apparatus of FIG. 1, electrical signals may be transmitted between inner assembly conductor wires 216 and outer assembly conductor wires 218 at the same time that outer cylindrical tube 208 of the outer assembly of slip ring apparatus 200 rotates relative to the inner assembly of slip ring apparatus 200.

Several drawbacks exist relating to the manufacture of existing cylindrical contact-type slip rings and with their implementation into CCTV applications. For example, wiring associated with the relatively long cylindrical aspects of such slip rings is difficult to route and connect due to the geometries associated with packaging of wires and contacts through the internal sections of the rotor and stator. When cylindrical contact-type slip rings are employed in CCTV applications, the length of the slip ring cylinder is one of the major components or contributing factors to the overall resultant camera height, which in turn drives the size of the dome enclosures required for internal and external building CCTV applications.

### SUMMARY OF THE INVENTION

Disclosed herein are low profile slip ring apparatus that may be advantageously implemented to enable low profile rotating systems for a variety of different applications including, but not limited to, articulated and non-articulated device applications (e.g. for camera devices, sensing devices, imaging devices, etc.). Specific examples of applications in which the disclosed slip ring apparatus may be advantageously implemented include, but are not limited to, CCTV applications, motion picture/filming camera applications, television studio camera applications, camcorder applications, military targeting applications (e.g., rotating mechanism for military camera/sensing/imaging devices and/or weapon devices), etc. The disclosed low profile slip ring apparatus may be advantageously employed in both continuous rotation (i.e. full 360 degree and beyond rotation) and non-continuous rotation (i.e., limited angle rotation of less than 360 degrees) slip ring applications.

In one embodiment, the disclosed slip ring apparatus may be configured with integrated position, velocity and/or acceleration feedback features that are reliable and easy to manufacture. For example, the slip ring assembly may be incorporated into a printed circuit board (“PCB”) with position, velocity and/or acceleration feedback circuitry, greatly simplifying the overall system and saving cost. This is in contrast to existing slip ring assemblies that employ separate slip ring and feedback mechanisms, which are more complex to manufacture and which require greater parts cost.

In one exemplary embodiment, a low profile (e.g., pan cake) slip ring having an integrated position feedback unit may be provided. The slip ring may include a number of conductive leaf springs attached to a circular printed circuit board. The slip ring may be used to transmit power and data from a stationary to a rotating element in an unrestrained and continuous rotation. The position feedback unit may consist of one or more tracks of spaced conductive segments on a circular printed circuit board which may be part of the rotor assembly. The stator may include one or more tracks of spaced conductive segments and is faced toward the side of the rotor and its conductive segments. Using this configuration, an alternating electrical signal may be applied to either the rotor or stator element, and resulting effects (e.g., capacitive, hall effect, and/or magneto-resistive effects) may be sensed from the opposite element. A ferro-fluidic type of liquid seal or other suitable seal may be used if desired to seal the entire assembly from dust, particles and other types of contamination.

In various embodiments of the disclosed slip ring apparatus, a number of exemplary features may be advantageously implemented, alone or in combination. Examples of such exemplary features include, but are not limited to, configuration of a slip ring apparatus by mounting of electrical conductive leaf springs on a circular printed circuit board to form a dynamic slip ring interface that allows contact with mating contacts in the form of electrical conductive traces present on an opposing rotary or stationary disk (e.g., which may also be a circular printed circuit board); reducing the number of signals required to cross the moving boundary in a slip ring configuration (e.g., using serial electronics); combination of a slip-ring assembly with a position, velocity, and/or acceleration feedback mechanism; and use of ferro-fluidics to seal the rotational interface of a slip ring housing.

In one respect, disclosed herein is a slip ring apparatus, including: a first slip ring component, the first slip ring component including a first interface surface and at least one first dynamic interface component; and a second slip ring component, the second slip ring component including a second interface surface and at least one second dynamic interface component. The first and second slip ring components may be rotatably coupled together on an axis of slip ring rotation so that the first and second interface surfaces are disposed in facing relationship to form a slip ring boundary therebetween with the axis of slip ring rotation being perpendicular to the plane of the slip ring boundary, and so that the first and second dynamic interface components are positioned to interact with each other to communicate at least one signal across the slip ring boundary.

In another respect, disclosed herein is a slip ring apparatus, including a first slip ring component and a second slip ring component. The first slip ring component may include a first slip ring component substrate that includes a circular platter having a first planar interface surface defined thereon, with at least one first dynamic interface component supported by the first slip ring component substrate. The second slip ring component may include a second slip ring substrate that includes a circular platter having a second planar interface surface defined thereon, with at least one second dynamic interface component supported by the second slip ring component substrate. The first and second slip ring components may be rotatably coupled together so that the first and second interface surfaces are disposed in mating facing relationship to form a slip ring boundary therebetween, and so that the first and second dynamic interface components are positioned to interact with each other to communicate at least one signal across the slip ring boundary at the same time at least one of the first and second slip ring components is rotating relative to the other of the first and second slip ring components.

In another respect, disclosed herein is a camera system, including an optical block coupled to a first slip ring apparatus that includes a moving first slip ring component and a stationary second slip ring component. The moving first slip ring component may have a first slip ring component substrate that includes a circular platter having a first planar interface surface defined thereon, and with at least one first dynamic interface component supported by the first slip ring component substrate. The second slip ring component may include a second slip ring substrate that includes a circular platter having a second planar interface surface defined thereon, and with at least one second dynamic interface component supported by the second slip ring component substrate. The first and second slip ring components may be rotatably coupled together so that the first slip ring component rotates relative to the second slip ring component, so that the first and second interface surfaces are disposed in mating facing relationship to form a slip ring boundary therebetween, and so that the first and second dynamic interface components are positioned to interact with each other to continuously communicate at least one signal across the slip ring boundary at the same time the first slip ring component is rotating relative to the second slip ring component. The optical block may be coupled to the first slip ring apparatus so that it rotates with the first slip ring component relative to the second slip ring component, with the first slip ring component being coupled between the optical block and the second slip ring component.

In another respect, disclosed herein is a method of communicating at least one signal across a slip ring boundary. The method may include providing a slip ring apparatus, that includes a first slip ring component and a second slip ring component. The first slip ring component may include a first interface surface and at least one first dynamic interface component, and the e second slip ring component may include a second interface surface and at least one second dynamic interface component. The first and second slip ring components may be rotatably coupled together on an axis of slip ring rotation so that the first and second interface surfaces are disposed in facing relationship to form the slip ring boundary therebetween, the axis of slip ring rotation being perpendicular to the plane of the slip ring boundary, and the first and second dynamic interface components being positioned to interact with each other to communicate at least one signal across the slip ring boundary. The method also may include rotating at least one of the first and second slip ring components about the axis of slip ring rotation relative to the other of the first and second slip ring components, and using the first and second dynamic interface components to communicate the at least one signal across the slip ring boundary simultaneously with the rotation.

### BRIEF DESCRIPTION OF THE DRAWINGS

FIG. 1A is a side perspective view of a commercially available slip ring.

FIG. 1B is an end perspective view of the commercially available slip ring of FIG 1A.

FIG. 2 is a perspective view of a commercially available slip ring.

FIG. 3 illustrates a first slip ring component according to one embodiment of the disclosed systems and methods.

FIG. 4A illustrates a second slip ring component according to one embodiment of the disclosed systems and methods.

FIG. 4B illustrates side and top views of a brush contact according to one embodiment of the disclosed systems and methods.

FIG. 5A illustrates a cross-sectional view of a rotatable optical block and slip ring apparatus assembly according to one embodiment of the disclosed systems and methods.

FIG. 5B illustrates a cross-sectional view of a dynamic seal area according to one embodiment of the disclosed systems and methods.

FIG. 6 illustrates a cross-sectional side view of a brush contact according to one embodiment of the disclosed systems and methods.

FIG. 7 illustrates a slip ring apparatus and slip ring cross boundary signals according to one embodiment of the disclosed systems and methods.

FIG. 8 illustrates a PTZ camera system configuration according to one embodiment of the disclosed systems and methods.

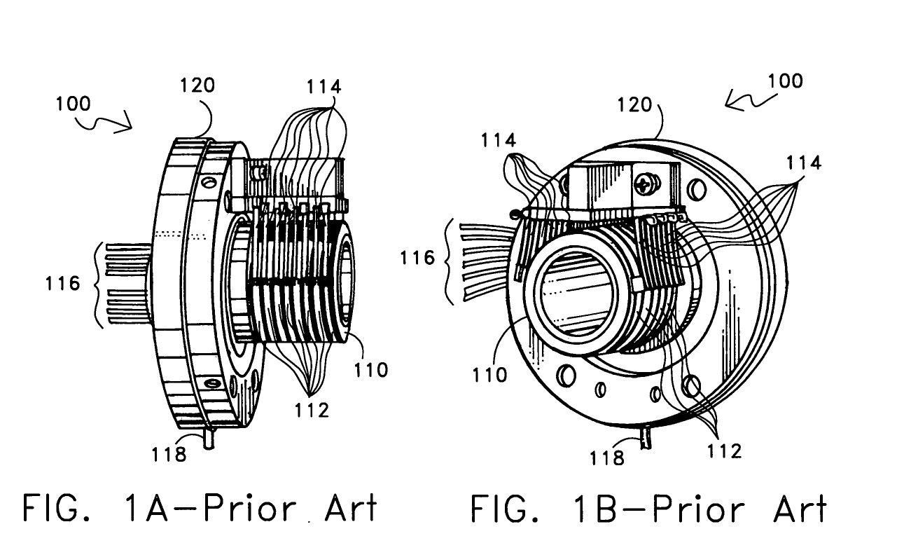

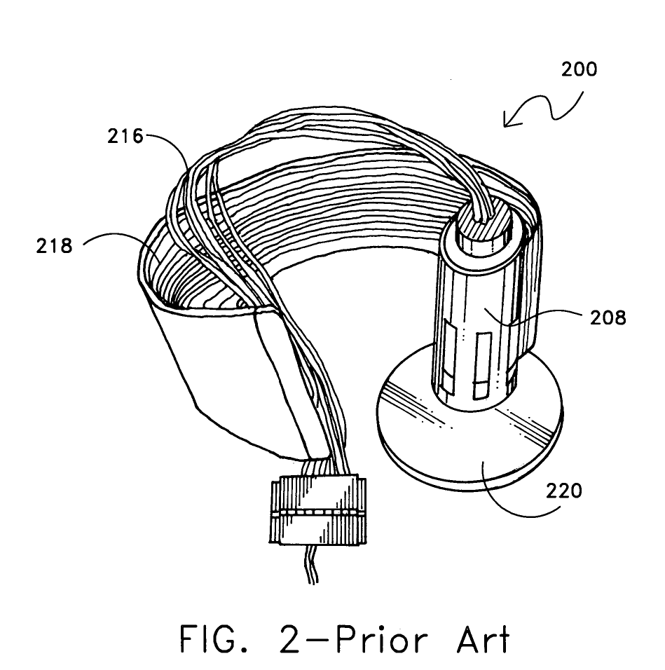

### DESCRIPTION OF ILLUSTRATIVE EMBODIMENTS

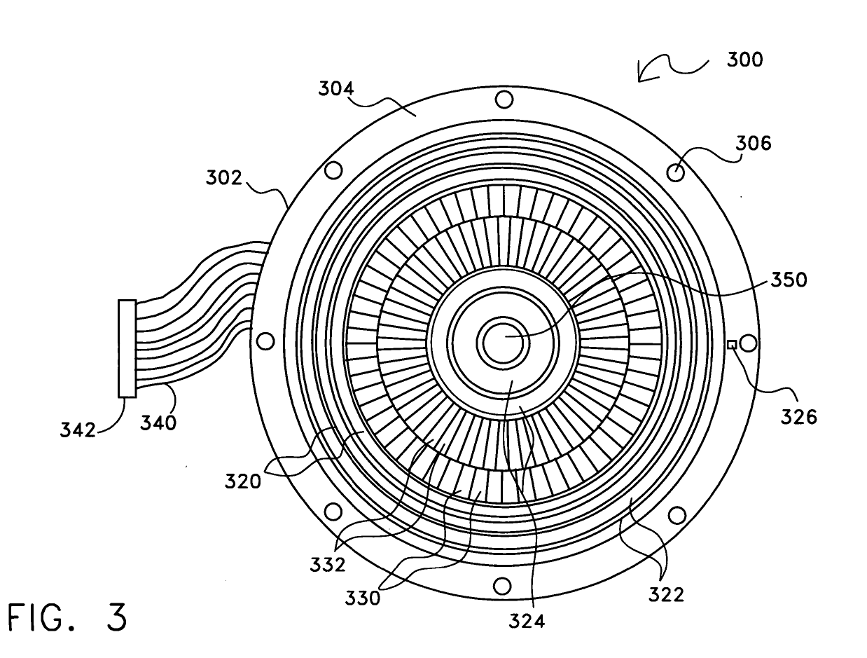

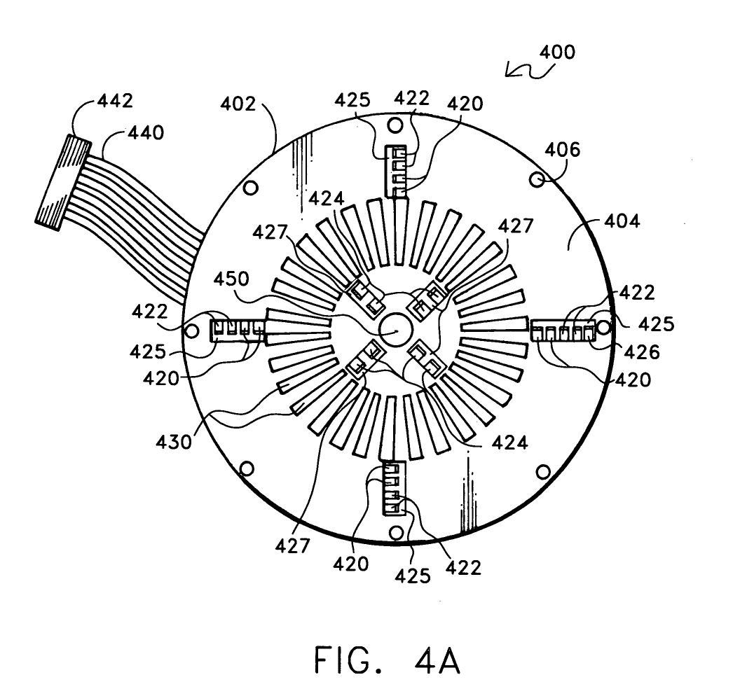

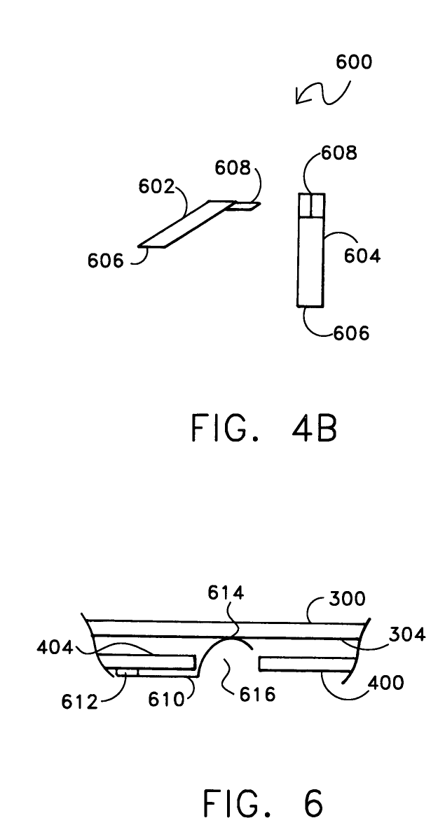

FIGS. 3 and 4A respectively illustrate first and second slip ring mating components 300 and 400 of an exemplary embodiment of a pancake (i.e., low profile) style slip ring assembly as it may be configured with conductive interface circuitry and an embedded position feedback mechanism. FIG. 3 shows an exemplary embodiment of a first slip ring component 300 of a slip ring assembly configured in the form of a circular board or platter, and FIG. 4 shows an exemplary embodiment of a second slip ring component 400 of a slip ring assembly configured in the form of a circular board or platter. The illustrated exemplary slip ring components 300 and 400 are two mating components that together form a slip ring apparatus having a dynamic interface for transmission of signals between circuitry of components 300 and 400. In this regard, first and second components 300 and 400 are configured with respective interface surfaces 304 and 404 that are capable of moving dynamically relative to each other in close proximity while at the same one or more signals are transmitted across a slip ring boundary formed by the space between interface surfaces 304 or 404 via respective first and second dynamic interface components that may be provided on surfaces 304 and 404, or otherwise on or within first and second components 300 and 400.

As shown in FIG. 3, exemplary first slip ring mating component 300 includes a first slip ring component substrate 302 having a planar interface surface 304 upon which first dynamic interface components may be disposed in a manner as will be further described below. In the illustrated exemplary embodiment, first slip ring component substrate 302 may be composed of a relatively thin PCB material (e.g., 0.062″ FR4 glass laminated epoxy sheet, etc.) upon which first dynamic interface components and other optional circuitry may be disposed. However, in other embodiments, a first slip ring component substrate may be composed of any other combination of one or more materials and geometry having a surface that is suitable for use as a dynamic interface surface capable of supporting dynamic interface components in operative relationship with mating dynamic interface components on a second slip ring component substrate, e.g., a substantially flat or planar surface. Examples of other suitable slip ring component substrate materials include, but are not limited to, glass-reinforced polycarbonate, magnesium alloys, polyphenylene sulfide, etc. Examples of other suitable slip ring component substrate geometries include, but are not limited to, cylindrical-shaped substrate configured on one end with a planar dynamic interface surface, non-circular-shaped substrate (e.g.,. oval, rectangular, etc) configured with circular (e.g., concentrically-arranged) dynamic interface components, slip ring component substrate geometries configured with circular dynamic interface components other than brush type components (e.g., such as spring loaded ball bearings that interface with circular conductive traces), etc. As used herein, a planar interface surface may be any surface that may be rotatably coupled in facing relationship with a corresponding planar interface surface to form a planar slip ring boundary interface therebetween in which the axis of rotation of one of the planar interface surfaces relative to the other planar interface surface is perpendicular to the plane of the slip ring boundary. Thus, a planar interface surface includes, but is not limited to, an interface surface that is flat and/or smooth across the entire surface; an interface surface that has undulating, rough or otherwise raised and/or depressed surface areas but that has one or more dynamic interface components configured to concentrically and rotatably mate with one or more corresponding dynamic interface components of another interface surface, etc.

Still referring to FIG. 3, first dynamic interface components are shown provided on surface 304 of first slip ring component 300 in the form of circular conductive traces 320, 322, 324; two tracks of radially-extending spaced conductive segments 330 and 332; and slip ring component alignment contact pad 326. In this exemplary embodiment, conductive traces 320 may be high speed differential serial traces, conductive traces 322 may be low speed serial traces, and conductive traces 324 may be power traces. In the practice of the disclosed systems and methods, conductive traces for a slip ring mating component may be of any material composition (e.g., conductive metal such as copper, copper alloy, silver or gold plated base metal, etc.) and/or dimensional form (e.g., flat, raised, domed, grooved, etc.) suitable for dynamically contacting and transmitting signals to, or receiving signals from, respective mating dynamic interface components (e.g., brushes, spring contacts, etc) disposed on a second slip ring mating component 400. For example, in one exemplary embodiment circular conductive traces 320, 322, 324 may be formed from about 0.004″ thick of gold plated copper alloy material on surface 304 of first slip ring component 300, with respective trace widths of about 0.040″, about 0.035″ and about .030″. A single contact, such as slip ring alignment contact pad 326, may be of similar material composition as conductive traces 320, 322, 324 and may be of any dimensional form (e.g., about 0.040″ by about .150″ square) that is suitable for transmitting signals to, or receiving signals from, one or more respective mating dynamic interface components (e.g., brushes, spring contacts, etc) disposed on a second slip ring mating component 400 when contacted by such mating dynamic components. It will be understood that the preceding conductive trace and contact pad dimensions are exemplary only, and that any other suitable dimensions may be employed.

Although one exemplary conductive trace configuration is illustrated in FIG. 3, it will be understood that any other suitable trace configuration may be employed (e.g., power may be on larger outside traces and high speed differential on the inner traces, etc). Not shown is the reduction of trace width for the outer differential signaling trace 320 relative to the inner differential signaling trace 320 that may be employed such that a more uniform transmission medium is maintained (i e., to maintain the same trace surface area and impedance the outer trace ring 320 may be configured to have a slightly smaller trace width than the adjacent inner trace ring 320).

In the illustrated exemplary embodiment of FIG. 3, an outer track of spaced conductive segments 330 are present on surface 304 of first slip ring component 300, adjacent an inner track of spaced conductive segments 332. In the practice of the disclosed systems and methods, spaced conductive segments for a slip ring mating component may be of any material composition (e.g., copper alloy, silver or gold plated spring steel, etc.) and/or dimensional form (e.g., circular, rectangular, square, etc.) suitable for dynamically moving in proximity to, but without contacting, mating dynamic interface components (e.g., mating spaced conductive segments) disposed on a second slip ring mating component 400 in order to transmit electronic signals between the first and second slip ring components as these slip ring components rotate relative to each other. For example, in one exemplary embodiment spaced conductive segments 330 and 332 may be respective segments of about .030″ and about 0.140″ in length configured in tracks having a respective width of about 0.025″ to about 0.040″, and may be formed of about 0.004″ thick of copper alloy material. In the exemplary embodiment of FIG. 3, spaced conductive segments 330 and 332 are present as capacitive sensor components that form a part of a position feedback mechanism for an assembled slip ring assembly. However, in other embodiments, one or more tracks of spaced conductive segments may be employed for any other signal transmitting purpose, e.g., multiple power/ground, analog video, Ethernet, or other serial or parallel analog or digital data, etc.

As shown in FIG. 4, exemplary second slip ring mating component 400 includes a second slip ring component substrate 402 having a planar interface surface 404 upon which second dynamic interface components may be disposed in a manner as will be further described below. In the illustrated exemplary embodiment, second slip ring component substrate 402 may be composed of a relatively thin PCB material (e.g., of the same type described above for first slip ring component 302) upon which second dynamic interface components and other optional circuitry may be disposed. However, in other embodiments, a second slip ring component substrate may be may be composed of any other combination of one or more materials and geometry having a surface that is suitable for use as a dynamic interface surface capable of supporting dynamic interface components in operative relationship with mating dynamic interface components on a first slip ring component substrate, e.g., a substantially flat or planar surface. Examples of other suitable slip ring component substrate materials and geometries for second slip ring mating component 400 include those described above for first slip ring mating component 300.

Still referring to FIG. 4, second dynamic interface components are shown provided on interface surface 404 of second slip ring component 400 in the form of brush contacts 420, 422, 424 (each configured in four sets and positioned at 90 degrees relative to each other); one track of radially-extending spaced conductive segments 430; and single slip ring component alignment brush contact 426. In this exemplary embodiment, brush contacts 420 are configured to extend from the back surface (i.e., surface opposite interface surface 404) through openings 425 defined in second slip ring component substrate 402 for continuously contacting and dynamically interfacing with high speed serial traces 320 of first slip ring mating component 300, brush contacts 422 are configured to extend from the back surface through openings 425 defined in second slip ring component substrate 402 for continuously contacting and dynamically interfacing with low speed serial traces 322 of first slip ring mating component 300, and brush contacts 424 are configured to extend from the back surface through openings 427 defined in second slip ring component substrate 402 for continuously contacting and dynamically interfacing with power traces 324 of first slip ring mating component 300. Brush contact 426 is configured for intermittently contacting and dynamically interfacing with alignment contact pad 326, e.g., to transmit an alignment signal across the boundary between first slip ring mating component 300 and second slip ring mating component 400 only when first slip ring mating component 300 and second slip ring mating component 400 are oriented in the relative position where brush contact 426 contacts alignment contact pad 326.

In the practice of the disclosed systems and methods, brush contacts for a slip ring mating component may be of any material composition (e.g., conductive metal such as silver graphite or copper/copper alloy with silver plating or gold plating; spring steel with silver or gold plating, carbon, etc.) and/or dimensional form (e.g., circular, oval, square, etc.) suitable for dynamically contacting and transmitting signals to, or receiving signals from, respective mating dynamic interface components (e.g., conductive traces, contact pads, etc) disposed on a first slip ring mating component 300. For example, in one exemplary embodiment brush contacts 420, 422, 424, 426 may be formed from copper with gold plating fixedly coupled to surface 404 of second slip ring component 400, with respective contact widths of about 0.030″, about 0.030″, about 0.040″ and about 0.030″. As a further example, FIG. 4B illustrates side view 602 and top view 604 of an exemplary embodiment of brush contact 600 having a mounting end 606 that may be fixedly coupled to a slip ring component and associated circuitry, such as second slip ring component 400 of FIG. 4A.

Also shown in FIG. 4B is contact end 608 of brush contact 600 configured for dynamically interfacing with dynamic interface components such as conductive traces 330, 332 or contact pad 326 of first slip ring component 300 of FIG. 3. Although a contact end of a brush contact may be configured with a single surface for contact, multiple contact points may be provided as shown by the split contact end 608 of brush element 608. When such a split contact end embodiment is employed, any debris that may be encountered by a contact end while sweeping around a mating conductive trace will tend to concentrate in specific groves, reducing the likelihood of the formation of an intermittent contact area due to contaminate build up perpendicular to the direction of motion. Also as illustrated in FIG. 4A, multiple brush contacts (e.g., four brush contacts) may be provided for a given mating conductive trace in order to maximize electrical conductivity. However, it will be understood that greater than four brush contacts, fewer than four brush contacts, or as few as one brush contact may be provided as needed or desired to dynamically interface with a corresponding conductive trace.

In the illustrated exemplary embodiment of FIG. 4A, one track of intermittently-spaced conductive segments 430 are present on surface 404 of second slip ring component 400, between brush contacts 420 and 424. Composition and dimensional form of conductive segments 430 may be as previously described in relation to conductive segments 330 and 332 of first slip ring mating component 300. In the illustrated exemplary configuration, intermittently-spaced conductive segments 430 are configured so as to face and rotatably interact with mating conductive segments 330 and 332 of first slip ring mating component 300 of an assembled slip ring apparatus. In this regard, intermittently-spaced conductive segments 430 are configured so as to dynamically move in proximity to, but without contacting, mating conductive segments 330 and 332 of first slip ring mating component 300 in order to transmit electronic signals between the first and second slip ring components 300 and 400 as these slip ring components rotate relative to each other. Together, the conductive segments 330, 332 and 432 may be implemented to form an integrated position feedback mechanism that can be used to sense the axial position of a subassembly, such as a camera optics assembly in the case of a pan-tilt-zoom camera with continuous pan motion, relative to the stationary assembly. Using this configuration, an alternating electrical signal may be applied to either conductive segments 330 and 332 of first slip ring components 300 or to conductive segments 430 of second slip ring component 400, and resulting effects (e.g., capacitive, hall effect, and/or magneto-resistive effects) may be sensed from the conductive segments of the mating or opposite slip ring component.

For example, referring to the exemplary embodiments of FIG. 3 and FIG. 4A, a capacitive type integrated position feedback mechanism may be implemented where one set of intermittently-spaced copper conductive segments 430 of second slip ring component 400 are excited with a multi-KHz or MHz periodic signal. The corresponding mating alternate conductive segments 330 and 332 of first slip ring mating component 300 may then receive the transmitted signal based on the relative position of the conductive segments. For example, when the copper pads of conductive segments 430 are in a position that directly overlays (or directly aligns with) the corresponding pads of conductive segments 330, the capacitance magnitude is maximized and a maximum signal amplitude is achieved. As second slip ring component substrate 402 is rotated relative to first slip ring component substrate 302 the common surface area between conductive segments 430 and conductive segments 330 decreases, which results in a decrease of capacitance and of signal amplitude. When the resultant periodic signal is demodulated, the final output would be sinusoidal in nature as the slip ring substrates rotate relative to each other.

As shown in FIG. 3, a second pattern of conductive segments 332 staggered relative to conductive segments 330 may also be provided on first slip ring mating component 300 to add a separate 90 degree phase shifted sinusoidal output that allows for finer position determination, especially in the area where the output from conductive segments 330 is at the top (90 deg) or bottom (270 deg) of the demodulated sinusoidal output. At that point, the slope of the sinusoid goes to zero which results in a very low feedback gain condition that would result in instability in most closed loop servo systems. The number of conductive segments (e.g., copper pads) provided in a given scenario sets the number of sinusoidal cycles produced per full revolution of one slip ring component relative to the other. To gain an initial absolute or “home” position, an alignment feature such as slip ring alignment contact pad 326 of first slip ring component 300 may be provided. In the illustrated embodiment, alignment contact pad 326 may be activated by separate brush contact 426 of separate slip ring component 400 once per revolution. The combination of this absolute home position and the relative position determined from conductive segments 330/332 and 430 (based on the number of cycles from the home position and the position within the sinusoidal cycle) may be used to provide continuous position feedback.

It will be understood that FIGS. 3 and 4A illustrate only one example configuration of dynamic interface components as they may be implemented on first and second slip ring mating components to form a slip ring apparatus. In this regard, any other configuration one or more pairs of mating dynamic interface components may be provided on respect mating slip ring components as desired or required to fit the needs of a given application. For example, it is possible that a greater or lesser number of mating dynamic interface components may be employed than are illustrated in FIGS. 3 and 4A. Further, different types and combinations of types of mating dynamic interface components than are illustrated in FIGS. 3 and 4A may be employed. In addition, the same types of mating dynamic interface components illustrated in FIGS. 3 and 4A (i.e., brush contacts mating with conductive traces, brush contact mating with contact pad, two tracks of conductive segments mating with one track of intermittently spaced conductive segments) may be provided but implemented in different configurations, e.g., in different relative locations on the mating surfaces of slip ring mating components, in differing numbers on the mating surfaces of slip ring mating components, etc.

It will also be understood that FIGS. 3 and 4A only illustrate exemplary embodiments of dynamic interface components, i.e., particular configurations of brush contacts, conductive traces, contact pad and conductive segment tracks. In this regard, first and second slip ring mating components of a slip ring apparatus may be configured with any alternative form/s of respective mating first and second dynamic interface components that are suitable for forming a dynamic interface through which one or more signals may be dynamically transmitted across the slip ring boundary of the slip ring apparatus. Examples of other types of suitable first and second mating dynamic interface components include, but are not limited to, cylindrical-shaped or spherical (e.g., ball bearing-shaped) contacts on a first slip ring component dimensioned to rollingly mate with conductive traces on a second slip ring component, etc. Further, it will be understood that dynamic interface components may be constructed of any material or combination of materials suitable for electrically conducting or otherwise facilitating dynamic transmission of a signal across a slip ring boundary (e.g., transmission of signal via capacitive effect, electromagnetic field, optical fibers, etc.). Examples of suitable conductive materials include, but are not limited to, conductive metals such as copper and alloys thereof, aluminum and alloys thereof, silver or gold plated base metal; conductive carbon-based materials such as graphite, etc. Examples of non-conductive or dielectric materials that may be employed to configure dynamic interface components include, but are not limited to, plastic, standard PC board material such as FR4, ceramic based materials, etc.

Selection of suitable combinations of materials and dimensional configurations of dynamic interface components may be made as needed or desired based on the characteristics and requirements of a given slip ring application (e.g., number and types of signals to transmit across the slip ring boundary, available space on the interface surfaces of respective slip ring components, constraints on overall size of slip ring apparatus and components thereof, constraints on cost of slip ring apparatus, available electrical power for transmission of signals across slip ring boundary, intended environmental conditions for slip ring apparatus implementation, etc.).

In the practice of the disclosed systems and methods, it will be understood that first and second dynamic interface components of respective first and second slip ring mating components of a slip ring apparatus may be electrically coupled to circuitry external to the slip ring apparatus, e.g., via conductors extending from one or more non-interface surfaces of a slip ring mating component to circuitry that is fixedly coupled to the respective slip ring mating component. For example, FIG. 3 illustrates conductors 340 that extend from the back side surface (i.e., surface opposite interface surface 304) of slip ring mating component 300 and terminate in connector 342. Similarly, FIG. 4A illustrates conductors 440 that extend from the back side surface (i.e., surface opposite interface surface 404) of slip ring mating component 400 and terminate in connector 442.

It will be understood that the illustrated configuration of conductors 340, 440 and connectors 342, 442 are exemplary only, and that any other configuration of one or more conductors and/or connectors may be provided on the back side surface, peripheral surface or any other suitable surface of a slip ring mating component to electrically couple dynamic interface components to circuitry external to the slip ring mating component. Furthermore, it will be understood that one or more dynamic interface components of a mating slip ring component may be alternatively or additionally electrically coupled to circuitry provided on-board the mating slip ring component (e.g., embedded or disposed on a surface of the mating slip ring component). In this regard, it is possible that a signal may be transmitted from a first slip ring mating component in one direction across a slip ring boundary via a dynamic interface formed between two mating slip ring components and then processed using circuitry on-board the slip ring mating component that received the signal, without ever being transmitted to circuitry external to the receiving slip ring mating component. Furthermore, the on-board processed signal may then be transmitted back across the slip ring boundary via the dynamic interface to the slip ring mating component that originally transmitted the signal.

Furthermore, it will be understood that alternative types of circuits and/or circuit methodologies may be implemented using the disclosed systems and methods to achieve similar or different purpose/s or functionalities than those described herein. For example, although the exemplary embodiment of FIGS. 3 and 4A illustrate one exemplary manner to implement a capacitive position feedback mechanism, other position feedback methodology may be implemented suing the disclosed systems and methods. For example, any other suitable position feedback mechanism/s may be employed including, but not limited to, magneto-resistive mechanism, hall effect mechanism, etc.

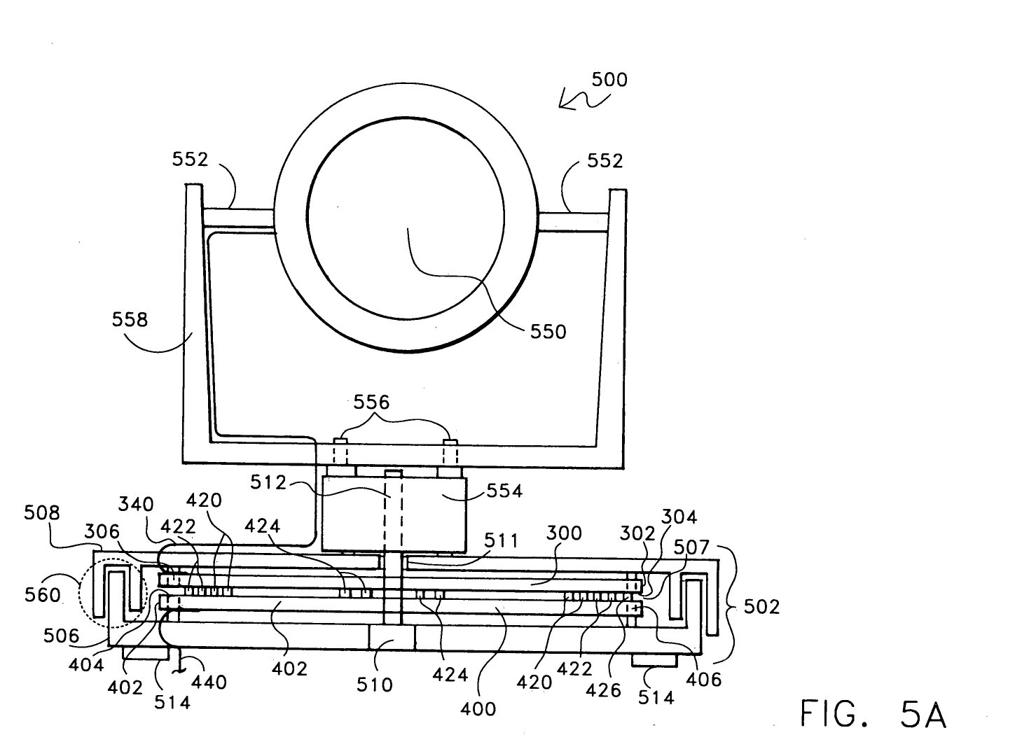

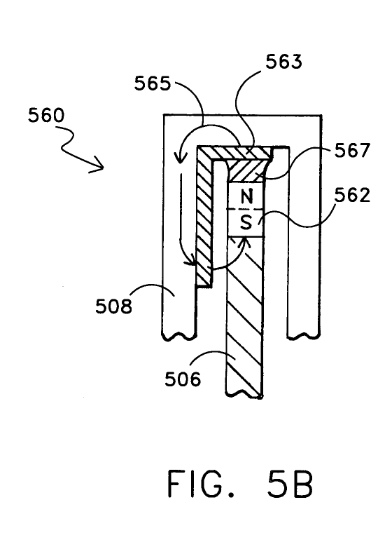

FIG. 5A illustrates one exemplary embodiment of a rotatable optical block and slip ring apparatus assembly 500 that includes a slip ring stack up assembly 502 rotatably coupled to an optical block assembly 550 (e.g., CCTV optical block assembly) to allow rotation of optical block assembly 550 in the pan axis direction (e.g., rotated about a vertical axis). As illustrated in FIG. 5A, slip ring stack up assembly 502 includes moving first slip ring mating component 300 rotatably coupled to a second stationary slip ring mating component 400 via spindle 512 (extending through respective openings 350 and 450 in substrates 302 and 402) so that respective interface surfaces 304 and 404 are disposed in mating facing relationship. In the configuration illustrated in FIG. 5A, first mating slip ring mating component 300 is capable of rotating on or with spindle 512 relative to second slip ring mating component 400 so that respective interface surfaces 304 and 404 are capable of moving dynamically relative to each other while at the same time signals are transmitted across slip ring boundary 507 formed by the space between interface surfaces 304 and 404. In this regard, signals are transmitted across slip ring boundary 507 via respective first and second dynamic interface components provided on or within first and second slip ring components 300 and 400 as previously described.

As shown in FIG. 5A, moving first slip ring component 300 and second stationary slip ring component 400 are rotatably coupled together on an axis of slip ring rotation so that respective first and second interface surfaces 304 and 404 are disposed in facing relationship to form slip ring boundary 507 therebetween, with the axis of slip ring rotation being perpendicular to the plane of slip ring boundary 507, and so that first and second dynamic interface components of the interface surfaces are positioned to interact with each other to communicate at least one signal across slip ring boundary 507.

In FIG. 5A, brush contacts 420, 422, 424 and 426 are visible extending from second slip ring component 400 to contact respective complementary dynamic interface components 320, 322, 324 and 326 (not visible in FIG. 5A). Also present but not visible are conductive segment tracks 330, 332 and 430 previously described in relation to FIGS. 3 and 4A. FIG. 6 illustrates a cross sectional side view of one exemplary embodiment of a brush contact 610 as it may be operatively disposed to dynamically interface between second slip ring component 400 and first slip ring component of FIG. 5A. In FIG. 6, mounting end 612 of brush contact 610 is fixedly coupled to second slip ring component 400 and associated circuitry on the surface opposite the interface surface 404 of second slip ring component 400 and extends through opening 616 so that contact end 614 dynamically contacts a respective dynamic interface component (not visible) on interface surface 304 of first slip ring component 300.

In the practice of the disclosed systems and methods, slip ring apparatus components may be optionally enclosed within a sealed or unsealed slip ring housing. For example, FIG. 5A illustrates one exemplary embodiment of a slip ring apparatus as it may be totally enclosed within a sealed slip ring housing (e.g.,. plastic housing or housing constructed of any other suitable material/s). In the illustrated embodiment, a sealed housing may be provided around slip ring mating components 300 and 400 by a combination of stationary housing base component 506 and moving housing component 508. Using suitable fasteners, second slip ring component 400 may be fixedly coupled to stationary housing base 506 using mounting holes 406, and likewise first slip ring component 300 may be fixedly coupled to moving housing component 508 using mounting holes 306. However, any other suitable mounting or fastening methodology may employed for the same purpose. As shown, spindle 512 may be fixedly coupled to stationary housing base 506 using any suitable coupling method, for example, using an optional reinforcement component 510 such as a metal insert piece that is embedded in stationary housing base 506 to provide sufficient strength for rotatably supporting moving housing component 508 and attached pan actuator 554, yoke 558 and optical block 550. Stationary housing base 506 may be in turn coupled to any suitable mounting location (e.g., floor, wall, ceiling, etc.) at housing attachment points 514, or in other suitable manner. Moving housing component 508 may be rotatably coupled to spindle 512, and may include optional sealing bushing 511 or other suitable rotating seal mechanism when a sealed environment is desired within a slip ring housing. It will be understood that a moving housing component may be rotatably coupled relative to a stationary housing component using any other suitable configuration, i.e., via a rotating spindle that is rotatably coupled by a bearing mechanism to the stationary housing component, etc.

In the practice of the disclosed systems and methods, an optical block or any other suitable moving component may be coupled to a first slip ring component in any manner suitable such that the optical block is rotatable with the first slip ring component relative to a second slip ring component. In the illustrated embodiments of FIG. 5A, pan actuator 554 is fixedly coupled to moving housing component 508 and to an optical block mounting member in the form of a yoke assembly 558 that supports and suspends an optical block assembly 550 via optical block mounting members 552 as shown. Optical block mounting members 552 may fixedly couple optical block 550 to yoke assembly 558 (as shown), or alternatively may rotatably couple optical block 550 to yoke assembly 558 (e.g., mounting members 552 may be a rotating shaft of a drive motor or drive gearbox) to provide rotation to optical block 550 in the tilt axis direction (e.g., rotated about a horizontal axis). As shown, optical block 550 may be electrically coupled to dynamic interface components on first slip ring component 300 via conductor 340, and dynamic interface components on second slip ring component 400 may be electrically coupled to circuitry external to assembly 500 via conductor 440. In this embodiment, first slip ring component 300 and moving housing component 508 move with yoke 558 while second slip ring component and housing base component 506 remain stationary. However, in another embodiment, a second slip ring apparatus may be implemented according to the disclosed systems and methods to allow rotation (and to provide a corresponding dynamic signal interface) to optical block 550 in the tilt axis direction.

Optical block assembly 550 may be any type of suitable optical block including, but not limited to, CCTV camera optical block, motion picture or studio television camera optical block, camcorder optical block, military targeting device optical block, imaging device optical bock, etc. Examples of suitable optical blocks that may be employed as optical block assembly 550 in the practice of the disclosed systems and methods include linear or folded optical blocks such as described and illustrated in concurrently filed U.S. patent application Ser. No. , entitled “OPTICAL BLOCK ASSEMBLY” by Hovanky et al. (Atty Dkt. COVI:006), and in concurrently filed U.S. patent application Ser. No. , entitled “SYSTEMS AND METHODS FOR ACTUATING LENS ASSEMBLIES” by Hovanky (Atty Dkt. COVI:004), each of which are incorporated herein by reference.

Still referring to FIG. 5A, actuator 554 may be any motor and/or gearbox assembly or other device suitable for rotating first slip ring component 300 (along with moving housing component 508, yoke 558 and optical block 550) in the pan axis relative to second slip ring component 400 and housing base 506. Examples of suitable actuators include, but are not limited to, conventional DC motors, stepper motors, etc. Other examples of suitable actuators include, but are not limited to, voice coil servo mechanisms as illustrated and described in concurrently filed U.S. patent application Ser. No. entitled “ELECTROMAGNETIC CIRCUIT AND SERVO MECHANISM FOR ARTICULATED CAMERAS” by Hovanky, et aL (Atty Dkt. COVI:003), which is incorporated herein by reference. In the exemplary embodiment of FIG. 5A, actuator 554 is shown fixedly coupled between moving housing component 508 and yoke 558 by fasteners 556, and operatively coupled to spindle 512 in a manner suitable to impart rotation to moving housing component 508 and yoke 558 relative to spindle 512 (e.g., using stationary core fixedly coupled to spindle 512 and rotating armature fixedly coupled to moving housing component 508 and yoke 558). However, an actuator may be alternatively coupled to impart rotation between first and second slip ring components in any other suitable manner, and/or a yoke or other suitable equipment mounting member may be coupled to a first slip ring component in any other suitable manner (e.g., by mounting device such as mounting bracket directly attached to moving housing component 508 and/or first slip ring component 300, etc.).

Although a slip ring apparatus is illustrated and described herein having a stationary slip ring component rotatably coupled to a moving slip ring component, it will be understood that the disclosed systems and methods may be implemented in any application having first and second slip ring components rotatably coupled together so that the two components rotate relative to each other, including those embodiments where both slip ring components are free to rotate. Furthermore, although FIG. 5A illustrates a slip ring apparatus as it may be implemented with a rotatable optical block assembly, it will be understood that the disclosed slip ring apparatus may be implemented to form a dynamic signal-passing interface boundary between two components of any type apparatus or assembly that need to rotate relative to each other while signals are dynamically transmitted across the boundary. Examples include, but are not limited to, those applications in which conventional slip ring apparatus have been employed. Specific examples of components other than optical block assemblies that may be rotatably coupled using the disclosed slip ring apparatus include, but are not limited to, laser pointing devices, robotic manipulators, rotating polishing and grinding equipment, optical projectors, scanners, etc.

As illustrated in FIG. 5A, a slip ring housing may be dynamically sealed in one exemplary embodiment so that the slip ring and housing assembly is sealed across the stationary-rotational boundary, e.g., using ferro-fluidic seal mechanism or any other suitable sealing mechanism. In this regard, moving housing component 508 includes a first peripheral sealing surface and stationary housing base component 506 includes a second peripheral sealing surface. As shown, the first and second peripheral sealing surfaces are configured to rotatably and sealably mate with each other to form a dynamic seal area 560 around the periphery of the assembled slip ring housing.

FIG. 5B illustrates one exemplary embodiment of dynamic seal area 560 having a magnet 562 molded or otherwise attached by any suitable method around the circumference of stationary housing base component 506 (e.g., plastic housing) as shown. In this regard, magnet 562 may be present for purposes of providing a magnetic field for stabilization and maintenance of a circumferential pocket of ferro-fluidic material 567 (e.g., for sealing purposes) within the dynamic sealing area 560 to form a ferrofluidic seal mechanism. A corresponding magnetic flux return member 563 (e.g. steel return plate) is molded or otherwise attached by any suitable method around the circumference of moving base component 508 adjacent to magnet 562 in order to provide a magnetic flux return path 565 as shown. In this configuration, magnet 562 acts to retain circumferential pocket of ferro-fluidic material 567 within the space existing between stationary housing base component 506 and moving housing component 508 (i.e., between magnet 562 and magnetic flux return member 563 in the illustrated embodiment).

Still referring to FIG. 5B, magnet 562 may be a rubberized or ceramic type magnet, or may be any other type of magnet material that acts to retain the ferro-fluidic material within the annular peripheral space/s existing between stationary housing base component 506 and moving housing component 508 in the dynamic seal area 560. A ferromagnetic fluid may be characterized as a colloidal suspension of submicron-sized magnetically permeable particles (e.g., Ferrofluid manufactured by Ferrotec Corporation of Nashua N.H., etc.) that is of suitable viscosity and lubricity to act as a fluid seal between stationary housing base, component 506 and moving housing component 508. It will be understood that the embodiment of FIG. 5B is exemplary only, and that any other configuration of ferrofluidic seal mechanism suitable for forming a circumferential dynamic seal between a stationary housing base component and a moving housing component may be employed. In this regard, it will be understood that a ferromagnetic fluid seal may be positioned in the magnetic field of a magnet using any suitable configuration such that a magnetic flux path travels through the contained pocket of ferromagnetic fluid in such a way as to contain the ferromagnetic fluid within the circumferential and/or annular peripheral space/s existing between a stationary housing base component and a moving housing component to form a dynamic seal area. For example a magnet may be attached or otherwise mounted to moving housing component and a corresponding magnetic flux return member attached or otherwise mounted to a stationary housing component, and/or one or more pockets of ferromagnetic fluid may be circumferentially contained at any other locations between suitable surfaces of a stationary housing component and moving housing component to form a dynamic seal.

Details of one exemplary embodiment of slip-ring apparatus that may be assembled from first and second slip ring components 300 and 400 of FIGS. 3 and 4 as part of an assembly 500 of FIG. 5A may be as follows. The substrates 302 and 402 of first and second slip ring components 300 and 400 may be printed circuit boards. In this embodiment, PCB thickness for substrates 302 and 402 may each independently be from about 0.04″ to about 0.062″, alternatively about 0.062″, although greater or lesser PCB thicknesses may also be suitably employed. The inner shaft opening of the assembled slip ring as defined by aligned central openings 350 and 450 of slip ring components 300 and 400 may be about 0.25″, and the outside diameter of the slip ring components 300 and 400 may be about 3.3″. Two inner conductive trace rings 324 may be provided on first slip ring component 300 for power and ground. Two outer conductive signal traces 322 on first slip ring component 300 may be for lower speed digital communication (bi-directional), and two intermediate conductive signal traces 320 may be for high-speed low voltage differential signaling (“LVDS”) digital video (two conductive traces 320 for uni-directional differential video signal). Tracks of conductive segments 330, 332 and 430 may be provided on respective first and second slip ring components 300 and 400 to implement a position feedback sensor drive. The ends of brush contacts 422, 424 and 425 may be split to reduce drag and to allow dust to be either be pushed to the side or to the middle. The inner power brush contacts 424 may be rotated 45 degrees to maintain the maximum board strength. A 360 degree PCB alignment point in the form of contact pad 326 may be provided on slip ring component 300 as a small copper square configured to align with a provided extra brush contact 426 on slip ring component 400 to determine the 0 degree point, e.g., when a camera is spun around at power up. Each slip ring component 300 and 400 may be mounted to its respective housing component 508 and 506 of the outer plastic housing, e.g., using flat head screws received through openings 306 and 406 that are flush with the top of the board. The slip ring boundary 507 may be formed by a board to board inner gap between first and second slip ring components 300 and 400 that is from about 0.03″ to about 0.06″, alternatively about 0.03″. Conductive traces 320, 322 and 324 and other conductive surfaces may be gold plated, and brush contacts 420, 422, 424 and 426 be made of silver graphite or copper/copper alloy with the appropriate plating/s (e.g., silver plating, gold plating, combinations thereof, etc.). It will be understood that the forgoing details are exemplary only, and that other configurations, dimensions and materials may be suitably employed.

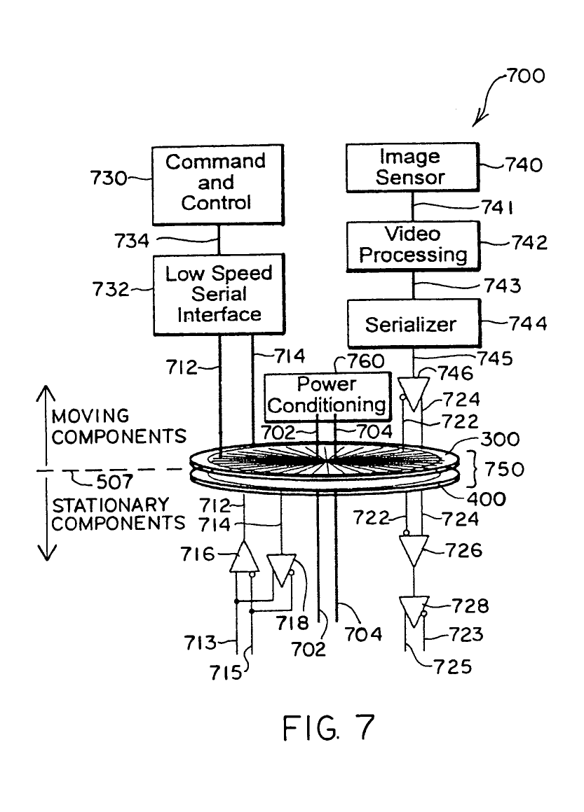

In one embodiment of the disclosed apparatus implemented with a rotatable optical block system, the number of signals crossing the slip ring rotational boundary (including power and ground signals) may be advantageously minimized to reduce mechanical complexity and increase the Mean Time Between Failure (″MTBF) of the slip-ring interface. For example, FIG. 7 illustrates one exemplary signal handling embodiment 700 for transmission of image, power and control signals across a slip ring boundary 507 of a slip ring apparatus 750 of a rotatable optical block (e.g., CCTV optical block) assembly, such as assembly 500 of FIG. 5A. As illustrated in FIG. 7, slip ring apparatus 750 includes moving first slip ring component 300 as a rotor element, and stationary second slip ring component 400 as a stator element. In this regard, first and second slip ring components 300 and 400 may be configured as described elsewhere herein.

As shown in the exemplary embodiment of FIG. 7, the number of signals communicated across slip ring boundary 507 has been reduced to six by the use of serial electronics. These signals include +/−dc power signals 702 and 704 (e.g., transmitted across boundary 507 by dynamic interface components 324 and 424 of FIGS. 3 and 4), a 2 wire bi-directional low speed serial interface for receive and transmit signals 712 and 714 (e.g., transmitted across boundary 507 by dynamic interface components 322 and 422 of FIGS. 3 and 4), and a 2 wire high speed differential serial digital video interface for signals 722 and 724 (e.g., transmitted across boundary 507 by dynamic interface components 320 and 420 of FIGS. 3 and 4).

As used to describe the exemplary embodiments herein, “low speed”refers to a bi-directional bus that is in the range of from about 5 to about 10 Mbit/sec, and “high speed” refers to an interface that is in the range of from about 500 to about 700 Mbit/sec. In the illustrated exemplary embodiment of FIG. 7, the low speed link may be configured to transition the boundary 507 as non-differential signals 712 and 714, whereas signals 722 and 724 of the high speed link may be configured to be differential in order to help maintain signal integrity, although this configuration is not necessary and other signal types and combinations thereof are possible. If desired, the high speed interface signaling may be regenerated after crossing the slip ring boundary 507 as shown using differential receiver 726 that is coupled to differential transmitter 728, e.g., to provide the capability of driving an extended length of cable.

Referring to the exemplary embodiment of FIG. 7 in more detail, optical block image sensor circuitry 740 (e.g., CMOS image sensor, CCD image sensor, etc.) may be configured to provide analog image signal 741 to video processing circuitry 742 that may operate to convert analog image signal 741 to digital video image signal 743. The parallel (i.e. multi-bit) Digital video signal 743 may then be provided to the parallel to serial conversion (serializer) circuitry 744 to produce digital serial video signal 745 that is provided to differential transmitter 746, which may provide differential video signals 722 and 724 to dynamic interface components of slip ring apparatus 750 for transmission across the slip ring boundary 507 via the dynamic interface of slip ring apparatus 750. After transmission across the slip ring boundary 507, differential video signals 722 and 724 may be regenerated by differential receiver 726 and differential transmitter 728, and then provided as high speed digital video signals 723 and 725 which may, for example, be applied to a shielded twisted pair cable for transmission of the serial digital video signal to a remote receiver which in turn may be coupled to further video processing circuitry (e.g., for regeneration back to analog video, storage of the digital video, image processing of the digital video, etc.).

Still referring to the exemplary embodiment of FIG. 7, low voltage differential signaling (“LVDS”) transceiver components (differential transmit circuitry 718 and differential receive circuitry 716) may be provided on the stator side of slip ring apparatus 750 to process the half-duplex differential signals 713 and 715, and respectively transmit and receive command and control signals 714 and 712 communicated across slip ring boundary 507 between stationary circuitry fixedly coupled to second slip ring component 400 and moving circuitry coupled to first slip ring component 300 on the rotor side of slip ring apparatus 750. On the rotor side of boundary 507, command and control signal 712 may be processed by low speed serial interface circuitry 732 that acts to deserialize and packetize the information into a parallel format suitable for further processing (e.g. extract the data packet from a UART based signal encoding scheme) that was transmitted to the low speed serial interface 732 from differential signals 713 and 715 via signal 712 across boundary 507. For transmission (i.e. from 732) the reverse procedure (i.e. de-packetization, UART encoding, and serialization) results in the serial digital signal 714 for transmission across b6undary 507.

For example, digital differential signaling concerning a forward control signal may be applied as signals 713 and 715 via a twisted pair cable and may originate from control circuitry (e.g., microprocessor or DSP) on the stator side of boundary 507. In an exemplary embodiment for camera control, examples of control information include, but are not limited to, optical block focus or zoom commands, rotation command for pan or tilt actuator, etc. The differential receiver 716 may convert the differential signaling to a non-differential (i.e. single ended) signal that transfers the control information 712 across the boundary 507 to the serial interface circuitry 732. Low speed serial interface circuitry 732 may receive and deserialize the serialized forward control signal 712 and provide deserialized forward control information across command and control interface 734 to command and control circuitry 730 which may process the forward command information and generate a command to the appropriate rotor-side mechanism (e.g., optical block focus or zoom actuator, pan or tilt actuator, etc.), not shown, to implement the original forward command. Likewise, return control information (e.g., image sensor operating temperature, optical block pan or tilt attitude information, raw zoom or focus position information, command completion status, etc.) may be provided from command and control circuitry 730 to low speed serial interface circuitry 732 across command and control interface 734. Low speed serial interface circuitry 732 may generate a serialized return control signal 714 based on the return command/control information and transmit this information via signal 714 across boundary 507 to the differential transmitter 718 that creates differential signals 713 and 715 for transmission to appropriate circuitry (e.g. a control microprocessor or DSP) that resides on the stator side of boundary 507.

As further illustrated in FIG. 7, power for rotor-side circuitry (e.g., circuitry of components 730, 732, 740, 742, 744 and 746) may be communicated across slip ring boundary 507 from a suitable stator-side power source. In this regard, any suitable ac or dc based power signals may be so communicated across slip ring boundary 507, however in the illustrated embodiment respective positive and negative dc power signals 702 and 704 may be provided from the stator side to power conditioning circuitry 760 on the rotor side of slip ring boundary 507 as illustrated. Power conditioning circuitry 760 may be may be any suitable circuitry for AC to DC or DC to DC power conversion and conditioning, and providing the conditioned power in suitable form to other rotor-side components such as the active rotor side circuitry shown in FIG. 7 and other circuitry not shown, such as a local servo control microprocessor or DSP, servo activation circuitry, position feedback circuitry, electromechanical components such as DC motors, solenoids, etc.

It will be understood that FIG. 7 illustrates just one exemplary signal handling embodiment that may be implemented in the practice of the disclosed systems and methods. In this regard, other types of signals and other combinations of additional and/or different types of signals may be communicated across a slip ring boundary in serialized or unserialized manner as may be desired or needed to fit the requirements of a given application. For example, radio frequency identification (“RFID”) related signals (e.g., RFID activation transmission signals, RFID tag response signals, etc.) may be communicated across a slip ring boundary to stator-side components from RFID components (e.g., RFID transceiver, RFID receiver, RFID transmitter, RFID differential antenna element/s, etc.) that are embedded or integrated in a camera assembly on the rotor-side of a slip ring apparatus. Examples of embedded or integrated RFID components and associated signals relater thereto may be found in illustrated and described in concurrently filed U.S. patent application Ser. No. ______, entitled “SYSTEMS AND METHODS FOR LOCATION OF OBJECTS” by Washington (Atty-Dkt. COVI:002), which is incorporated herein by reference.

Furthermore, although FIG. 7 illustrates an exemplary embodiment having 6 signals 702, 704, 712, 714, 722 and 724 communicated across slip ring boundary 507, it will be understood that in other embodiments the number of signals may vary, e.g., greater than 6 signals less than 6 signals, and that the number of dynamic interface components (e.g., conductive traces) may vary accordingly. For example, in one alternative embodiment, a differential pair and power and ground signals may be employed to achieve a number of signals less than 6. In another embodiment, up to 12 signals may be present, with a corresponding increase in number of dynamic interface components, e.g., increase in number of conductive traces and in diameter of circular boards or platters of first and second slip ring components as may be required to fit the number and width of the additional traces. These are exemplary values only, and the number of signals may vary further according to the needs of the desired application.

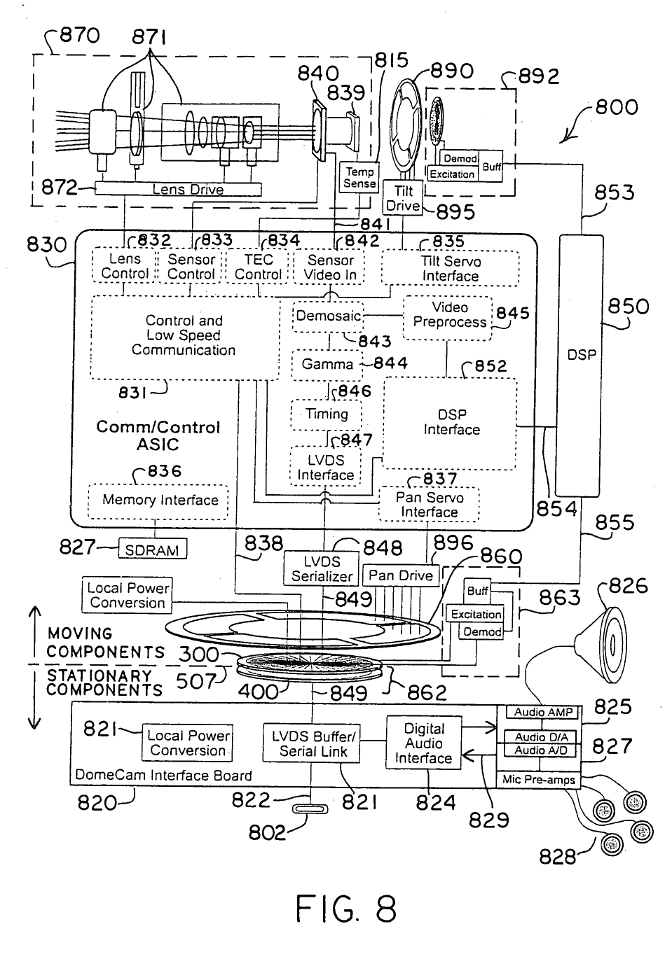

FIG. 8 schematically illustrates one exemplary embodiment of the disclosed systems and methods as it may be implemented in a pan/tilt/zoom (“PTZ”) camera system implementation 800 employing a slip ring/sensor apparatus 862. In one embodiment, the illustrated components of FIG. 8 may be implemented as part of a remote camera dome assembly module that, for example, may be coupled via a dome camera interface board 820 and high speed connector 802 to a multi-camera CCTV network used for surveillance or other purposes, or alternately coupled to a local video processing and analysis unit used to process the video information and provide local control of the PTZ camera via the high speed connector 802. FIG. 8 depicts one exemplary way in which signals may interact with various components of system 800. As shown in FIG. 8, system 800 includes optical block 870 that is configured for rotation in a pan axis and a tilt axis. Tilt drive actuator 890 and pan drive actuator 860 are provided to impart controlled rotation to optical block 870 in its respective tilt and pan axes. To enable rotation in the pan axis direction and to provide a dynamic signal interface, pan drive actuator 860 is coupled between optical block 870 and moving first slip ring component 300 of slip ring apparatus 862, which may have a PCB slip ring component substrate that includes integrated or embedded circuitry. In this exemplary embodiment, a command/control ASIC 830 is provided that may be present as embedded or integrated circuitry in the PCB substrate of first slip ring component 300, but alternatively may be configured on the rotor side (e.g., same side as slip ring component 300) of slip ring apparatus 862 in any other suitable manner, e.g., located on the camera optical block housing assembly, etc. As illustrated, ASIC 830 is coupled between the circuitry of optical block 870 and the dynamic interface components of slip ring apparatus 862.

As shown in FIG. 8, optical block 870 (e.g., a CCTV optical block) includes optical components 871, lens drive circuitry 872, and image sensor 840 that produces high speed serial video data 841 that may be provided to low level video processing circuitry components of communication/control ASIC 830. These video processing circuitry components may include, for example, a parallel digital video and sensor control interface 842, Bayer RGB demosaicing circuitry 843, gamma correction 844 and sensor and video timing circuitry 846. The video preprocessor 845 may receive component video from the demosaic engine 844 and perform further processing such as hardware based spatial frequency processing, histogram processing used for exposure control, etc. This information may be provided to the local DSP 850 via the DSP interface 852. DSP 850 may then use this information to control the zoom and focus mechanisms in 870, Infrared (“IR”) lens block mechanism (carrying an IR filter) shown in 870, TEC 839 in 870, as well as sensor exposure control and any type of suitable mechanical IRIS (not shown). As shown, video data 841 may be successively processed by components 842, 843, 844, 845 and 846 in order to provide a properly formatted and conditioned parallel digital video stream prior to transmission of the video data by LVDS interface 847 and LVDS serializer 848. In this regard, LVDS serializer 848 may be a standard Serializer/Deserializer (“SerDes”) part using 8b/10b encoding or other suitable serializer that receives parallel processed digital video signal from LVDS interface 847 of ASIC 830 and produces serialized digital video data signal 849 for communication across slip ring boundary 507 of slip ring apparatus 862 to LVDS buffer/serial link 821 of the dome camera interface board 820 where it may be buffered and regenerated for signal quality purposes and communicated over communication link 822 to other components of camera network or local video processing attached to the high speed connector 802. Although LVDS serializer 848 is illustrated as being circuitry external to ASIC 830, it will be understood that LVDS serializer 848 may alternatively be a SerDes function that is embedded into the ASIC.

Other components that may be present as part of ASIC 830 include memory interface circuitry 836 that may be coupled to any suitable memory device (e.g., external memory 827 such as SDRAM or other suitable external memory device), and control and low speed communication circuitry 831 that is coupled to achieve control of one or more rotor-side components of camera system 800 (e.g., control of the focus, zoom, pan and tilt position, image sensor, image sensor cooling, and/or general communication). In the illustrated embodiment, control and low speed communication circuitry 831 is shown coupled to lens control circuitry 832, image sensor control circuitry 833, thermoelectric cooler control circuitry 834, tilt servo interface 835 and pan servo interface 837 as shown). In operation, control and low speed communication circuitry 831 may receive forward low speed serial control signals 838 from across slip ring boundary 507 (e.g., based on control information provided across a network via high speed connector 802). Based on received control signals 838, control and low speed communication circuitry 831 may in turn provide control signals for controlling one or more of optical components 871 (e.g., via lens control circuitry 832 and lens drive circuitry 872), image sensor 840 (e.g., via sensor control 833), thermoelectric cooler (“TEC”) 839 (e.g., via TEC control 834), tilt drive actuator 890 (e.g., via tilt servo interface 835 and tilt drive circuitry 895) and pan drive actuator 860 (e.g., via pan drive servo interface 837 and pan drive circuitry 896). Thus, one or more rotor-side components of camera system 800 may be remotely controlled by control signals provided from the stator-side side of slip-ring apparatus 862, e.g., by signals originating from administrator, operator or central processor of camera network coupled via high speed connector 802.

As illustrated in FIG. 8, control and low speed communication circuitry 831 of ASIC 830 may also be configured to receive operational information from one or more rotor-side components of camera system 800 and to transmit signals based on this operational information to boundary 507 as return low speed serial control signals 838. For example, control and low speed communication circuitry 831 may receive image sensor temperature information from temperature sensor circuitry 815 and TEC control circuitry 834, and provide this information as a return control signal 838. In this way, operating parameters of one or more rotor-side components of camera system 800 may be monitored remotely using return control signals provided from the rotor side to the stator side of slip-ring apparatus 862, e.g., to allow operational monitoring of camera system 800 by administrator, operator or central processor of camera network coupled via high speed connector 802.

Also illustrated in FIG. 8 is local digital signal processor (“DSP”) 850 that may be present as circuitry residing on the rotational part of the overall assembly, e.g., as embedded or integrated circuitry of the PCB substrate of slip ring component 300, or as external circuitry fixedly coupled to slip ring component 300 so that it rotates with same. In the illustrated exemplary embodiment, DSP 850 may locally control one or more rotor-side components of camera system 800 using local control signals 854 exchanged with control and low speed communication circuitry 831 via DSP interface circuitry 852. In this regard, local control signals from DSP 850 may be used to control one or more components of system 800 in the same manner as forward control signals 838 may be used to remotely control the same one or more components, but without need for communication of signals across boundary 507 of slip ring apparatus 862. As shown, DSP 850 may also be coupled to provide control signals 853 and 855 to feedback and signal conditioning circuitry 863, 892 in order to form a local closed loop servo positioning system for pan and tilt control of the camera line of sight (LOS). In one exemplary embodiment, feedback and signal conditioning circuitry 863 may be configured with excitation circuitry to drive intermittently-spaced conductive segments of one of first slip ring component 300 or second slip ring component 400, and may also be configured with demod and buffer circuitry to receive corresponding signals from the opposing intermittently-spaced conductive segments of the other of first slip ring component 300 or second slip ring component 400, and to provide these signals to DSP 850.

Local control on the rotor-side of a slip ring apparatus (e.g., using rotor-side DSP) may be advantageously employed to greatly reduce the required number of signals going across the rotational boundary of the slip ring apparatus. For purposes of comparison, in conventional CCTV applications the number of signals communicated across a boundary of a conventional contact-type cylindrical slip ring apparatus typically range from 12 to 16. These may include CCIR656 video (8 bits of data plus clock), position feedback, motor control (focus, iris, zoom, pan, tilt), and power and ground.

As shown for the exemplary embodiment of FIG. 8, dome camera interface board 820 may also be provided with local power conversion circuitry 821 that acts to provide local power conditioning and conversion for the power used by the circuitry and electromechanical component shown in FIG. 8. This power may originate as a single voltage at the high speed connector interface 802. Dome camera interface board 820 also may include audio reception processing circuitry 827 (e.g., microphone pre-amplifiers, audio analog to digital converter) that may be coupled between external microphone/s 827 and digital audio interface 824 to allow sounds to be obtained from an area around the camera dome assembly simultaneously with the video data from image sensor 840. Audio processing circuitry 827 may provide a digital audio signal 829 based on analog signal obtained by microphones 828 to digital audio interface 824, which in turn may provide the audio signal to LVDS buffer/serial link 821 for communication to a network or local audio/video processing unit coupled via high speed connector 802 through communication link 822. Furthermore, dome camera interface board 820 may further include audio production processing circuitry 825 (e.g., audio digital to analog converter, audio amplifier) that may be coupled between digital audio interface 824 and external speaker/s 826 to allow sounds to be broadcast to the area surrounding the camera dome assembly. In this regard, digital audio signals may be received from a network or local audio/video processing unit coupled via high speed connector 802 by LVDS serial link/buffer 821 over communication link 822 and provided to audio production processing circuitry 825 via digital audio interface board 824.

It will be understood that the disclosed embodiment of FIG. 8 is exemplary only, and that one or more described features of the camera system 800 may be implemented separately or in combination with any one or more other described features of camera system 800, or with one or more other features as may be desirable or needed to meet the requirements of a given application. In this regard, the particular rotor-side components illustrated in FIG. 8 are exemplary only, and it is possible that different types of optical blocks (having different lens component combinations), different drive actuator configurations (no tilt drive actuator may be present, no pan actuator may be present and moving slip ring component of a slip ring apparatus 862 instead fixedly coupled to a tilt drive actuator), etc. may be alternatively employed. Furthermore, it will be understood that ASIC 830 may be configured with additional or fewer circuitry components, and that DSP 850 may or may not be present on the rotor-side of slip ring apparatus 862. Whether or not DSP 850 is present, a system 800 may be configured so that all control of rotor side components may originate remotely from the stator side of the slip ring apparatus 862. Alternatively, a camera system 800 may be provided with only local control capability, e.g., using one or more DSP 850 units as the sole source of control of rotor-side components.

It will also be understood that the disclosed slip-ring apparatus may be employed with external circuitry, e.g., rotor and stator separate from control/command circuitry, image processing circuitry, feedback circuitry, etc. In such an embodiment, the same rotor and stator geometry with the same dynamic interface components (e.g., conductive traces, brushes, conductive segment tracks configured as previously described) may be implemented on separate rotor and stator components that may be constructed of any suitable material including, but not limited to, plastic (e.g., traces and brushes embedded in respective plastic components). Further alternatively, at least one of the rotor or stator may be a PCB having at least a portion of the feedback circuitry embedded therein or thereon, with the other one of the rotor or stator being a non-PCB material. It will also be understood that the illustrated pan drive and tilt drive assemblies are exemplary only, and that any other motor or device suitable for driving the slip ring may be employed including, but not limited to, stepper motor, etc. Furthermore, it will be understood that either of the slip ring components (i.e., ring with traces or ring with brushes) may rotate, with the other slip ring component remaining stationary.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed apparatus and methods may be utilized in various combinations and/or independently. Thus the invention is not limited to only those combinations shown herein, but rather may include other combinations.

### REFERENCES

The following references, to the extent that they provide exemplary system, apparatus, method, or other details supplementary to those set forth herein, are specifically incorporated herein by reference.

U.S. Provisional patent application serial No. 60/437,713 entitled “Systems And Methods For Location Of Objects”, by Richard G. Washington, (attorney docket COVI:002PZ1).

Concurrently filed U.S. patent application Ser. No. ______ entitled “Systems And Methods For Location Of Objects”, by Richard G. Washington, (attorney docket COVI:002).

U.S. Provisional patent application serial No. 60/437,711 entitled “Electromagnetic Circuit And Servo Mechanism For Articulated Cameras”, by Thao D. Hovanky, (attorney docket COVI:003PZ1).

Concurrently filed U.S. patent application Ser. No. ______ entitled “Electromagnetic Circuit And Servo Mechanism For Articulated Cameras”, by Thao D. Hovanky et al., (attorney docket COVI:003).

U.S. Provisional patent application serial No. 60/437,710 entitled “Systems And Methods For Actuating Lens Assemblies”, by Thao D. Hovanky, (attorney docket COVI:004PZ1).

Concurrently filed U.S. patent application Ser. No. ______ entitled “Systems And Methods For Actuating Lens Assemblies”, by Thao D. Hovanky, (attorney docket COVI:004).

U.S. Provisional patent application Serial No. 60/437,690 entitled “Optical Block Assembly”, by Thao D. Hovanky and Richard G. Washington, (attorney docket COVI:006PZ1).

Concurrently filed U.S. patent application Ser. No. ______ entitled “Optical Block Assembly”, by Thao D. Hovanky and Richard G. Washington, (attorney docket COVI:006).

U.S. Provisional patent application serial No. 60/437,709 entitled “Thermoelectric Cooled Imaging Apparatus”, by Richard G. Washington and Thao D. Hovanky, (attorney docket COVI:007PZ1).

Concurrently filed U.S. patent application Ser. No. ______ entitled “Thermally Cooled Imaging Apparatus”, by Richard G. Washington and Thao D. Hovanky, (attorney docket COVI:007).

U.S. Provisional patent application serial No. 60/456,294 entitled “Systems And Methods For Creation, Transmission, And Viewing Of Multi-Resolution Video”, by Richard G. Washington, (attorney docket COVI:008PZ1).

What is claimed is:

1. A slip ring apparatus, comprising:
a first slip ring component, said first slip ring component comprising a first interface surface and at least one first dynamic interface component; and
a second slip ring component, said second slip ring component comprising a second interface surface and at least one second dynamic interface component;
wherein said first and second slip ring components are rotatably coupled together on an axis of slip ring rotation so that said first and second interface surfaces are disposed in facing relationship to form a slip ring boundary therebetween, said axis of slip ring rotation being perpendicular to the plane of said slip ring boundary, and said first and second dynamic interface components being positioned to interact with each other to communicate at least one signal across said slip ring boundary.

2. The slip ring apparatus of claim 1, wherein said first and second dynamic interface components are positioned to interact with each other to communicate at least one signal across said slip ring boundary at the same time at least one of said first and second slip ring components is rotating about said axis of slip ring rotation relative to the other of said first and second slip ring components.

3. The slip ring apparatus of claim 2, wherein said first slip ring component comprises a first slip ring component substrate and wherein said second slip ring component comprises a second slip ring component substrate, each of said first and second slip ring component substrates comprising a circular platter.

4. The slip ring apparatus of claim 2, wherein said first slip ring component comprises a first slip ring component substrate and wherein said second slip ring component comprises a second slip ring component substrate, at least one of first and second slip ring component substrates comprising a printed circuit board.

5. The slip ring apparatus of claim 2, wherein said first and second dynamic interface components comprise components of position sensor circuitry.

6. The slip ring apparatus of claim 5, wherein said first and second dynamic interface components each comprise tracks of intermittently-spaced conductive segments that form capacitive sensor components of a position sensor mechanism.

7. The slip ring apparatus of claim 2, wherein said at least one of first and second slip ring component substrates comprises a printed circuit board, said printed circuit board comprising position sensor circuitry.

8. The slip ring apparatus of claim 2, wherein said first slip ring component comprises a moving first slip ring component substrate; wherein said second slip ring component comprises a stationary second slip ring component substrate; and wherein said first and second dynamic interface components are positioned to interact with each other so as to communicate at least one signal across said slip ring boundary at the same time said moving first slip ring component is rotating about said axis of slip ring rotation relative to said stationary second slip ring component.

9. The slip ring apparatus of claim 2, wherein said first dynamic interface component comprises at least one of a conductive trace or a contact pad; and wherein said second dynamic interface component comprises a brush contact.

10. The slip ring apparatus of claim 1, wherein said first slip ring component comprises a printed circuit board and is configured to be coupled to an optical block so that said optical block is rotatable with said first slip ring component relative to said second slip ring component; and wherein said printed circuit board of said first slip ring component comprises at least one of control circuitry for said optical block, image processing circuitry for said optical block, power conversion circuitry for said optical block, or a combination thereof.

11. The slip ring apparatus of claim 1, wherein said first and second dynamic interface components are positioned to interact with each other to communicate at least one signal across said slip ring boundary at the same time at least one of said first and second slip ring components is rotating about said axis of slip ring rotation relative to the other of said first and second slip ring components, said at least one signal comprising a forward or return optical block control signal, an optical block image signal, or an optical block power signal.

12. The slip ring apparatus of claim 1, wherein said first slip ring component comprises a printed circuit board and is configured to be coupled to a drive actuator so that said drive actuator is capable of imparting rotation to said first slip ring component relative to said second slip ring component; and wherein said printed circuit board of said first slip ring component comprises control circuitry for said drive actuator.

13. The slip ring apparatus of claim 1, further comprising a first housing component fixedly coupled to said first slip ring component, and a second housing component fixedly coupled to said second slip ring component so that said first and second slip ring components are disposed between said first and second housing components.

14. The slip ring apparatus of claim 3, further comprising a first housing component fixedly coupled to said first slip ring component, and a second housing component fixedly coupled to said second slip ring component so that said first and second slip ring components are disposed between said first second housing components and so that said first and second housing components form a slip ring housing around said first and second slip ring components; wherein said first housing component comprises a first circular peripheral sealing surface and wherein said second housing component comprises a second circular peripheral sealing surface; and wherein said first circular peripheral sealing surface of said first housing component rotatably and sealably mates with said second circular peripheral surface of said second housing component to form a dynamic seal around the periphery of said slip ring housing.

15. A slip ring apparatus, comprising:
a first slip ring component, said first slip ring component comprising a first slip ring component substrate that comprises a circular platter having a first planar interface surface defined thereon, and at least one first dynamic interface component supported by said first slip ring component substrate; and
a second slip ring component, said second slip ring component comprising a second slip ring substrate that comprises a circular platter having a second planar interface surface defined thereon, and at least one second dynamic interface component supported by said second slip ring component substrate;
wherein said first and second slip ring components are rotatably coupled together so that said first and second interface surfaces are disposed in mating facing relationship to form a slip ring boundary therebetween, and so that said first and second dynamic interface components are positioned to interact with each other to communicate at least one signal across said slip ring boundary at the same time at least one of said first and second slip ring components is rotating relative to the other of said first and second slip ring components.

16. The slip ring apparatus of claim 15, wherein said first and second dynamic interface components are positioned to interact with each other to continuously communicate said at least one signal across said slip ring boundary at the same time said at least one of said first and second slip ring components is rotating relative to said other of said first and second slip ring components.

17. The slip ring apparatus of claim 16, wherein said at least one signal at least one signal communicated across said slip ring boundary comprises a forward or return optical block control signal, an optical block image signal, or an optical block power signal.

18. The slip ring apparatus of claim 16, wherein each of said first and second slip ring component substrates comprise a printed circuit board; wherein said first slip ring component is configured to be coupled to an optical block so that said optical block is rotatable with said first slip ring component relative to said second slip ring component; and wherein said printed circuit board of said first slip ring component comprises at least one of control circuitry for said optical block, image processing circuitry for said optical block, power conversion circuitry for said optical block, or a combination thereof.

19. The slip ring apparatus of claim 18, wherein said at least one signal communicated across said slip ring boundary comprises multiple signals transmitted across said slip ring boundary, said multiple signals comprising a forward or return optical block control signal, a processed optical block image signal, and an optical block power signal.

20. The slip ring apparatus of claim 18, wherein said first slip ring is configured to be coupled to a drive actuator so that said drive actuator is capable of imparting rotation to said first slip ring component relative to said second slip ring component; and wherein said printed circuit board of said first slip ring component further comprises control circuitry for said drive actuator.

21. The slip ring apparatus of claim 19, wherein said first slip ring component comprises a moving first slip ring component substrate; wherein said second slip ring component comprises a stationary second slip ring component substrate; and wherein said first and second dynamic interface components are positioned to interact with each other so as to communicate at least one signal across said slip ring boundary at the same time said moving first slip ring component is rotating relative to said stationary second slip ring component.

22. The slip ring apparatus of claim 21, wherein said first dynamic interface component comprises at least one of a conductive trace or a contact pad; and wherein said second dynamic interface component comprises a brush contact.

23. The slip ring apparatus of claim 22, wherein said first dynamic interface component comprises a first track of intermittently-spaced conductive segments, and wherein said second dynamic interface component comprises a second track of intermittently-spaced conductive segments; said first and second tracks of intermittently-spaced conductive segments being positioned to interact with each other without contacting to form a position sensor mechanism.

24. The slip ring apparatus of claim 23, further comprising a first housing component fixedly coupled to said first slip ring component, and a second housing component fixedly coupled to said second slip ring component so that said first and second slip ring components are disposed between said first and second housing components.

25. The slip ring apparatus of claim 24, wherein said first and second housing components form a slip ring housing around said first and second slip ring components; wherein said first housing component comprises a first circular peripheral sealing surface and wherein said second housing component comprises a second circular peripheral sealing surface; and wherein said first circular peripheral sealing surface of said first housing component rotatably and sealably mates with said second circular peripheral surface of said second housing component to form a dynamic seal around the periphery of said slip ring housing.

26. The slip ring apparatus of claim 25, wherein said dynamic seal comprises a ferro-fluidic seal.

27. A camera system, comprising:
a first slip ring apparatus, said first slip ring apparatus comprising:
a moving first slip ring component, said first slip ring component comprising a first slip ring component substrate that comprises a circular platter having a first planar interface surface defined thereon, and at least one first dynamic interface component supported by said first slip ring component substrate, and
a stationary second slip ring component, said second slip ring component comprising a second slip ring substrate that comprises a circular platter having a second planar interface surface defined thereon, and at least one second dynamic interface component supported by said second slip ring component substrate,
wherein said first and second slip ring components are rotatably coupled together so that said first slip ring component rotates relative to said second slip ring component, so that said first and second interface surfaces are disposed in mating facing relationship to form a slip ring boundary therebetween, and so that said first and second dynamic interface components are positioned to interact with each other to continuously communicate at least one signal across said slip ring boundary at the same time said first slip ring component is rotating relative to said second slip ring component; and
an optical block coupled to said first slip ring apparatus so that it rotates with said first slip ring component relative to said second slip ring component, said first slip ring component being coupled between said optical block and said second slip ring component.

28. The camera system of claim 27, further comprising a first drive actuator coupled to said first slip ring apparatus to impart rotation to said first slip ring component and said optical block relative to said second slip ring component.

29. The camera system of claim 28, wherein said first drive actuator comprises a voice coil servo mechanism coupled between said first slip ring component and said optical block.

30. The camera system of claim 28, wherein each of said first and second slip ring component substrates comprise a printed circuit board; and wherein said printed circuit board of said first slip ring component comprises at least one of control circuitry for said optical block, image processing circuitry for said optical block, power conversion circuitry for said optical block, control circuitry for said first drive actuator, or a combination thereof.

31. The camera system of claim 28, wherein said at least one signal communicated across said slip ring boundary comprises multiple signals transmitted across said slip ring boundary, said multiple signals comprising a forward or return optical block control signal, a processed optical block image signal, and an optical block power signal.

32. The camera system of claim 28, wherein each of said first and second slip ring component substrates comprise a printed circuit board; and wherein said printed circuit board of said first slip ring component comprises control circuitry for said optical block, image processing circuitry for said optical block, power conversion circuitry for said optical block, and control circuitry for said first drive actuator.

33. The camera system of claim 32, wherein said at least one signal communicated across said slip ring boundary comprises multiple signals transmitted across said slip ring boundary, said multiple signals comprising a forward or return optical block control signal, a processed optical block image signal, and an optical block power signal.

34. The camera system of claim 31, wherein each of said multiple signals is communicated across said slip ring boundary by at least one first dynamic interface component to at least one second dynamic interface component; wherein said first dynamic interface component comprises a conductive trace and said second dynamic interface component comprises a brush contact; and wherein said first and second dynamic interface components are positioned to continuously contact each other to communicate said at least one signal across said slip ring boundary at the same time said first slip ring component is rotating relative to said second slip ring component.

35. The camera system of claim 28, wherein said first dynamic interface component comprises a first track of intermittently-spaced conductive segments, and wherein said second dynamic interface component comprises a second track of intermittently-spaced conductive segments; said first and second tracks of intermittently-spaced conductive segments being positioned to interact with each other without contacting to form a position sensor mechanism.

36. The camera system of claim 30, wherein said first dynamic interface component comprises a first track of intermittently-spaced conductive segments, and wherein said second dynamic interface component comprises a second track of intermittently-spaced conductive segments; said first and second tracks of intermittently-spaced conductive segments being positioned to interact with each other without contacting to form a position sensor mechanism.

37. The camera system of claim 28, further comprising a first housing component fixedly coupled to said first slip ring component, and a second housing component fixedly coupled to said second slip ring component so that said first and second slip ring components are disposed between said first and second housing components.

38. The camera system of claim 37, wherein said first and second housing components form a slip ring housing around said first and second slip ring components; wherein said first housing component comprises a first circular peripheral sealing surface and wherein said second housing component comprises a second circular peripheral sealing surface; and wherein said first circular peripheral sealing surface of said first housing component rotatably and sealably mates with said second circular peripheral surface of said second housing component to form a dynamic seal around the periphery of said slip ring housing.

39. The camera system of claim 38, wherein said dynamic seal comprises a ferro-fluidic seal.

40. The camera system of claim 28, wherein said first drive actuator is coupled to said first slip ring apparatus to impart rotation to said first slip ring component and said optical block in a pan axis direction; and wherein said camera system further comprises a second slip ring apparatus coupled to said optical block and a second drive actuator coupled to said second slip ring apparatus to impart rotation to said optical block in a tilt axis direction.

41. The camera system of claim 28, wherein said second slip ring apparatus comprises:
a moving first slip ring component, said first slip ring component of said second slip ring apparatus comprising a first slip ring component substrate that comprises a circular platter having a first planar interface surface defined thereon, and at least one first dynamic interface component supported by said first slip ring component substrate of said second slip ring apparatus; and
a stationary second slip ring component, said second slip ring component of said second slip ring apparatus comprising a second slip ring substrate that comprises a circular platter having a second planar interface surface defined thereon, and at least one second dynamic interface component supported by said second slip ring component substrate of said second slip ring apparatus;
wherein said first and second slip ring components of said second slip ring apparatus are rotatably coupled together so that said first slip ring component of said second slip ring apparatus rotates relative to said second slip ring component of said second slip ring apparatus, so that said first and second interface surfaces of said second slip ring apparatus are disposed in mating facing relationship to form a slip ring boundary of said second slip ring apparatus therebetween, and so that said first and second dynamic interface components of said second slip ring apparatus are positioned to interact with each other to continuously communicate at least one signal across said slip ring boundary of said second slip ring apparatus at the same time said first slip ring component of said second slip ring apparatus is rotating relative to said second slip ring component of said second slip ring apparatus; and
wherein said optical block is coupled to said second slip ring apparatus so that it rotates with said first slip ring component of said second slip ring apparatus relative to said second slip ring component of said second slip ring apparatus, said first slip ring component of said second slip ring apparatus being coupled between said optical block and said second slip ring component of said second slip ring apparatus.

42. A method of communicating at least one signal across a slip ring boundary, comprising:
providing a slip ring apparatus, comprising:
a first slip ring component, said first slip ring component comprising a first interface surface and at least one first dynamic interface component, and
a second slip ring component, said second slip ring component comprising a second interface surface and at least one second dynamic interface component,
wherein said first and second slip ring components are rotatably coupled together on an axis of slip ring rotation so that said first and second interface surfaces are disposed in facing relationship to form said slip ring boundary therebetween, said axis of slip ring rotation being perpendicular to the plane of said slip ring boundary, and said first and second dynamic interface components being positioned to interact with each other to communicate at least one signal across said slip ring boundary;
rotating at least one of said first and second slip ring components about said axis of slip ring rotation relative to the other of said first and second slip ring components; and
using said first and second dynamic interface components to communicate said at least one signal across said slip ring boundary simultaneously with said rotation.

43. The method of claim 42, wherein said first and second dynamic interface components comprise components of position sensor circuitry, and wherein said method further comprises using said first and second dynamic interface components to sense a position of said first slip ring component relative to said second slip ring component using.

44. The method of claim 42, further comprising rotating said first slip ring component while holding said second slip ring component stationary.

45. The method of claim 42, wherein said first dynamic interface component comprises at least one of a conductive trace or a contact pad; and wherein said second dynamic interface component comprises a brush contact.

46. The method of claim 42, wherein said first slip ring component comprises a printed circuit board; wherein said method further comprises providing an optical block coupled to said first slip ring component so that said optical block is rotatable with said first slip ring component relative to said second slip ring component, and rotating said optical block with said first slip ring component; and wherein said printed circuit board of said first slip ring component comprises at least one of control circuitry for said optical block, image processing circuitry for said optical block, power conversion circuitry for said optical block, or a combination thereof.

47. The method of claim 42, wherein said first slip ring component comprises a printed circuit board; and wherein said method further comprises:
providing an optical block coupled to said first slip ring component so that said optical block is rotatable with said first slip ring component relative to said second slip ring component;
rotating said optical block with said first slip ring component; and
controlling said optical block at least in part using circuitry of said printed circuit board, or processing image data from said optical block at least in part using circuitry of said printed circuit board, or providing power for said optical block at least in part using circuitry of said printed circuit board, or a combination thereof.

48. The method of claim 42, wherein said method further comprises providing an optical block coupled to said first slip ring component so that said optical block is rotatable with said first slip ring component relative to said second slip ring component, and rotating said optical block with said first slip ring component; and wherein said at least one signal comprises a forward or return optical block control signal, an optical block image signal, or an optical block power signal.

49. The method of claim 42, wherein said first slip ring component comprises a printed circuit board; and wherein said method further comprises:
providing a drive actuator coupled to said first slip ring component;
using said drive actuator to rotate said first slip ring component relative to said second slip ring component; and
controlling said drive actuator at least in part using circuitry of said printed circuit board.

50. The method of claim 49, wherein said method further comprises:
providing an optical block coupled to said first slip ring component so that said optical block is rotatable with said first slip ring component relative to said second slip ring component;
using said drive actuator to rotate said first slip ring component and said optical block relative to said second slip ring component; and
controlling said optical block at least in part using circuitry of said printed circuit board, or processing image data from said optical block at least in part using circuitry of said printed circuit board, or providing power for said optical block at least in part using circuitry of said printed circuit board, or a combination thereof.

51. The method of claim 42, further comprising providing a first housing component fixedly coupled to said first slip ring component, and a second housing component fixedly coupled to said second slip ring component so that said first and second slip ring components are disposed between said first and second housing components.

52. The method of claim 42, wherein said first slip ring component comprises a first slip ring component substrate and wherein said second slip ring component comprises a second slip ring component substrate, each of said first and second slip ring component substrates comprising a circular platter; and wherein said method further comprises:
providing a first housing component fixedly coupled to said first slip ring component, and a second housing component fixedly coupled to said second slip ring component so that said first and second slip ring components are disposed between said first second housing components and so that said first and second housing components form a slip ring housing around said first and second slip ring components;
wherein said first housing component comprises a first circular peripheral sealing surface and wherein said second housing component comprises a second circular peripheral sealing surface; and
wherein said first circular peripheral sealing surface of said first housing component rotatably and sealably mates with said second circular peripheral surface of said second housing component to form a dynamic seal around the periphery of said slip ring housing.
